(19) United States
(12) Patent Application Publication
(10) Pub. No.: US 2008/0213724 A1
(43) Pub. Date: Sep. 4, 2008

(54) Kit For Repairing, Supplementing And Relining Dental Prostheses In A Dentist's Practice

(75) Inventors: Albert Erdrich, Bad Nauheim (DE); Karl-Heinz Renz, Frankfurt (DE); Novica Savic, Erlensee (DE)

Correspondence Address: NORRIS, MCLAUGHLIN & MARCUS, P.A., 875 THIRD AVE, 18TH FLOOR, NEW YORK, NY, 10022, US

(73) Assignee: Heraeus Kulzer GmbH, Hanau (DE)

(21) Appl. No.: 10/574,440

(22) PCT Filed: Nov. 19, 2004
(86) PCT No.: PCT/EP04/13141

§ 371 Date: Apr. 4, 2006

(30) Foreign Application Priority Data
Nov. 28, 2003 (DE) 103 56 366.0

(51) Int. Cl. A61C 13/00

(52) U.S. Cl. 433/167

(57) ABSTRACT

Dental prosthesis repair kit, including a light-curing dental prosthesis repair material, a diamond grinder for the end of a dentist's tool holder, and a bonding agent solution.

The patent concerns a set for the dentist, which allows for the repair, addition and restoration of prosthetics in the practice.

If damages occur to the dental prosthesis, e.g., such as a crack, the patient must then search out a dentist who can perform a repair in the dental laboratory. As a rule, that means that the patient must do without the prosthesis for hours to days long.

Changes in the mouth position of the wearer lead to the dental prosthetic no longer precisely fitting. For the adjustment of this, the dentist must likewise use a technical dental laboratory. Currently, there are two methods available for this:

### 1. Direct Restoration:

Through application of a synthetic material (“cold polymer resin”) to the prosthesis and subsequent use in the mouth, the missing section will be restored. After hardening of the synthetic material, the restored prosthetic will then be appropriately reworked. Due to possible allergies and heat buildup from the bonding of the cold polymer resin to the mucous membrane in the mouth and the inadequate opportunity for reworking, this process is controversial. For example, there is a product on the market for direct restoration (Lightdon U from the Dreve firm), which has the disadvantage that it is hardened extraorally. As a result, this can lead to material movement during the removal.

### 2. Indirect Restoration:

A casting material is used on the prosthesis and this “prosthetic cast”, which in principle performs the same casting function as for full dentures, is processed accordingly, in a dental laboratory—such as for the manufacturing of a new prosthesis. In this way, a replacement of the prosthetic base, which is against the mucous membrane in the mouth, occurs—replacement teeth and (any) braces or other holding elements remain unchanged. The disadvantage is the very long waiting time (in some cases up to 2 days).

In order to remedy the outlined situation, a kit has been developed that contains everything necessary for a repair right at the dental practice. In particular, it consists of a set for repairs, additions and restorations of dental prosthetics in the dental practice. The kit consists of a light curing repair material, a diamond grinder on the end of the dentist's tool holder, and a bonding agent solution. As an option, a mixing plate can also be added.

The repair material is beneficially a light-curing, one-component prosthetic synthetic, e.g., the following composition: a networked organic matrix of dimethacrylate and multifunctional meth/acrylates, (Trade name “Versyo® direct”, from Kulzer). The components are, among others: Trimethylporpylidintrimethaycryalate (CAS: 3290-92-4), aliphatic Urethanacrylate; Bisphenole-A-ethoxylate (2) dimethacrylate (CAS: 24448-20-2) (CAS: 24448-20-2) and 2.2-Dimethoxy-1.2-diphenyl-ethan-1-on (CAS: 24650-42-8).

The material is fundamentally compatible with the conventional synthetics of polymethymethacrylate base. Because of this, repairs and restorations can also be made to older prostheses.

A broken prosthesis will be repaired with it as follows:

The surface to be repaired is secured and drilled with a medium grain sized diamond.

The secured surface is completely brushed with Versyo® bond bonding agent and allowed to penetrate for at least 60 seconds.

After that, the conditioned surface is lightly polymerized.

The Versyo® direct is applied and molded on the repair area.

Depending on the lamp and the size of the repair area, the polymerization time should amount to 30-40 seconds per cm².

The advantage exists primarily in the time savings for the patient. A further advantage is that all materials that are compatible with each other are consolidated. For this reason, it cannot lead to a mix-up or a combination of incompatible materials in the practice.

A restoration can be undertaken with the kit, based on the patent, as follows:

### Direct Restoration

Rid the prosthetic base of moisture and contamination. Treat basal surface extensively and clear away at least 1 mm of material. After that, drill treated area with a medium grain sized diamond (125 μm). The secured surface is completely brushed with Versyo® bond bonding agent and allowed to penetrate for at least 60 seconds. After that, the conditioned surface is lightly polymerized. The polymerization time should amount to 10 seconds per cm², during which the polymerization lamp should be held as close as possible to the conditioned surface.

Apply Versyo® direct extensively to the basal surface and lightly pass over the surface. Prevent large excesses because otherwise the danger exists that the material will end up in the spaces between the teeth or throat area of the patient. Position the prosthetic in the patient's mouth and place it in the correct position. As soon as the prosthetic is correctly placed, polymerize with the polymerization lamp through the prosthetic base, whereby you must pay attention to sufficient selective exposure of areas that are hard to access with the light. The polymerization lamps can be directly touched during the exposure of the bridge so that the entering light can be as deeply permeated as possible.

Depending on the lamp and the size of the repair area, the polymerization time should amount to at least 30 seconds per cm². After successful polymerization of all areas, the prosthetic should be taken out again and “basal insulating gel” (gel made of a glycerin/silica base) applied in order to eliminate the dispersion layer, concluding with basal polymerization at 30 seconds per cm².

The preparation takes place with carbide milling and rubberizing or sandpaper. The finishing can be carried out with the conventional composite polishing.

1. A set for repair, additions and restorations of dental prostheses in the dental practice, comprising
A. a light curing repair material
B. a diamond grinder for the end of the dentist's tool holder
C. a bonding agent solution.

2. The set of claim 1, further comprising a mixing plate.

3. A method for repair, addition or restoration of dental prosthetics in the dental practice, which comprises performing such repair, addition or restoration with the set of claim 1.

4. The method of claim 3 for repair of dental prosthetics in the dental practice.

5. The method of claim 3 for restoration of dental prosthetics in the dental practice.

6. The method of claim 3 for the addition of dental prosthetics in the dental practice.
